(19) United States
(12) Patent Application Publication
(10) Pub. No.: US 2015/0140417 A1
(43) Pub. Date: May 21, 2015

(54) SEALED BATTERY

(71) Applicant: HITACHI MAXELL, LTD., Osaka (JP)

(72) Inventors: Hiroshi Matsumoto, Ibaraki-shi (JP); Yoshihiko Aizawa, Ibaraki-shi (JP); Mayumi Yamamoto, Ibaraki-shi (JP); Hiroshi Maesono, Ibaraki-shi (JP); Kenta Kogo, Ibaraki-shi (JP)

(73) Assignee: HITACHI MAXELL, LTD., Osaka (JP)

(21) Appl. No.: 14/546,533

(22) Filed: Nov. 18, 2014

(30) Foreign Application Priority Data
Nov. 19, 2013 (JP) 2013-238625

(51) Int. Cl. H01M 2/02; H01M 2/04; H01M 10/052; H01M 2/30

(52) U.S. Cl. CPC H01M 2/0277; H01M 2/30; H01M 2/04; H01M 2/0404; H01M 2/043; H01M 10/052
USPC 429/179

(57) ABSTRACT

To obtain a configuration in which an insulator arranged between a lid plate and a terminal is not damaged by heat generated during welding in a sealed battery including a battery case obtained by welding an outer peripheral edge portion of a lid plate to an opening portion of an outer can. A sealed battery 1 includes a battery case 2, a negative electrode terminal 22, and an insulating packing 21 arranged between the battery case 2 and the negative electrode terminal 22. The battery case 2 has an outer can 10 having at least one opening portion 16, and a lid plate 20 welded to the opening portion 16 of the outer can 10 at an outer peripheral edge portion 20c while the opening portion 16 is covered. The negative electrode terminal 22 is electrically connected to an electrode assembly 30 through the lid plate 20.

### BACKGROUND OF THE INVENTION

1. Field of the Invention

The present invention relates to a sealed battery, the battery case of which is formed by welding an outer can and a lid plate together, and in which battery case an electrode assembly and an electrolyte are enclosed.

2. Description of the Related Art

Conventionally, there has been known a sealed battery including a battery case that is provided with an outer can constituting a side surface of the battery case and having at least one opening portion, and a lid plate arranged so as to cover the opening portion of the outer can. In the sealed battery as described above, the battery case is constructed by welding an outer peripheral edge portion of a battery lid (the lid plate) to an opening portion of a battery can (the outer can) as disclosed in Japanese Patent Laid-Open No. 2003-31186, for example.

The opening portion of the battery can (the outer can) and the outer peripheral edge portion of the battery lid (the lid plate) are generally welded by laser welding as disclosed in Japanese Patent Laid-Open No. 2003-31186. When the opening portion of the battery can (the outer can) and the outer peripheral edge portion of the battery lid (the lid plate) are irradiated with laser light, the opening portion and the outer peripheral edge portion of the battery lid (the lid plate) are melted by the heat of the laser light, and the molten portion is then cooled to be joined together.

Generally, a terminal that is electrically connected to an electrode assembly arranged within the battery case penetrates the lid plate of the sealed battery. The terminal is electrically connected to one of a positive electrode and a negative electrode of the electrode assembly. On the other hand, the battery case is electrically connected to the other of the positive electrode and the negative electrode of the electrode assembly. The outer can is joined to the lid plate by welding as in the battery disclosed in Japanese Patent Laid-Open No. 2003-31186 above. Therefore, the lid plate assumes the same potential as the outer can electrically connected to the other of the electrodes. That is, in the sealed battery, the terminal and the battery case including the lid plate are electrically connected to the electrodes different in polarity from each other. Since the terminal penetrates the lid plate as described above, the sealed battery includes an insulator arranged between the terminal and the lid plate so as to prevent the occurrence of short circuit between the terminal and the lid plate.

### SUMMARY OF THE INVENTION

By the way, when the outer peripheral edge portion of the lid plate is welded to the opening portion of the outer can as described above, heat generated during welding is transferred through the lid plate. The temperature of the lid plate thereby increases, so that the insulating member arranged on the lid plate could be damaged by the heat.

An object of the present invention is to obtain a configuration in which the insulator arranged between the lid plate and the terminal is not damaged by the heat generated during welding in the sealed battery including the battery case obtained by welding the outer peripheral edge portion of the lid plate to the opening portion of the outer can.

A sealed battery according to one embodiment includes: a columnar battery case in which an electrode assembly and an electrolyte are enclosed; a terminal that projects outward from the battery case; and an insulator that is arranged between the battery case and the terminal. The battery case has an outer can having at least one opening portion and constituting a side surface of the battery case, and a lid plate welded to the opening portion of the outer can at an outer peripheral edge portion while the opening portion is covered. The terminal is electrically connected to the electrode assembly through the lid plate. In the lid plate, a heat transfer inhibiting portion is provided between a weld portion of the lid plate with the opening portion of the outer can and the insulator.

In accordance with the sealed battery according to one embodiment, it is possible to prevent the insulator from being damaged by heat generated by welding.

### BRIEF DESCRIPTION OF THE DRAWINGS

FIG. 1 is a perspective view illustrating the schematic configuration of a sealed battery according to an embodiment;

FIG. 2 is a sectional view along a line II-II in FIG. 1; and

FIG. 3 is an enlarged sectional view illustrating a weld portion of a battery case in an enlarged manner.

### DETAILED DESCRIPTION OF THE PREFERRED EMBODIMENTS

A sealed battery according to one embodiment includes: a columnar battery case in which an electrode assembly and an electrolyte are enclosed; a terminal that projects outward from the battery case; and an insulator that is arranged between the battery case and the terminal. The battery case has an outer can having at least one opening portion and constituting a side surface of the battery case, and a lid plate welded to the opening portion of the outer can at an outer peripheral edge portion while the opening portion is covered. The terminal is electrically connected to the electrode assembly through the lid plate. In the lid plate, a heat transfer inhibiting portion is provided between a weld portion of the lid plate with the opening portion of the outer can and the insulator.

In the above configuration, heat generated when the opening portion of the outer can and the outer peripheral edge portion of the lid plate are welded together can be inhibited from being transferred to the insulator through the lid plate. That is, since the heat transfer inhibiting portion is provided between the weld portion and the insulator in the lid plate, the heat transfer inhibiting portion can inhibit the heat generated by welding from being directly transferred to the insulator. Accordingly, it is possible to prevent the insulator from being damaged by the heat generated by welding.

The heat transfer inhibiting portion is provided in a portion on the lid plate where a distance between the insulator and the weld portion is shortest. Accordingly, the heat generated by welding can be more efficiently inhibited from being transferred to the insulator by the heat transfer inhibiting portion. That is, the heat generated by welding is most easily transferred to the insulator in the portion where a distance between the weld portion and the insulator is shortest, so that the temperature of the insulator easily increases by welding. Therefore, by providing the heat transfer inhibiting portion in the portion where a distance between the weld portion and the insulator is shortest, the heat transfer from the weld portion to the insulator can be more effectively inhibited.

The heat transfer inhibiting portion is provided at a position on the lid plate where a distance to the weld portion is shorter than a distance to the insulator. Accordingly, the heat generated during welding can be efficiently inhibited from being transferred by the heat transfer inhibiting portion. That is, since the heat transfer inhibiting portion is provided at the position where a distance to the weld portion is shorter than a distance to the insulator, the heat transfer inhibiting portion can efficiently inhibit the heat transfer before the heat generated during welding in the weld portion is extensively diffused over the lid plate.

The heat transfer inhibiting portion is a concave-convex portion formed on an outer surface of the lid plate. By providing the concave-convex portion on the outer surface of the lid plate, a transfer path through which the heat generated during welding in the weld portion is transferred to the insulator can be made longer than that of a case in which the outer surface is a flat surface. Accordingly, the heat transfer from the weld portion to the insulator can be inhibited. Also, by providing the concave-convex portion on the outer surface of the lid plate, a surface area of the lid plate can be made larger, and a cooling area of the lid plate can thereby be made larger. Therefore, the heat generated by welding can be efficiently dissipated outside of the lid plate.

The heat transfer inhibiting portion is a concave portion formed on an outer surface of the lid plate. When a convex portion is provided on the outer surface of the lid plate, the convex portion could interfere with a device to which the battery is attached since the convex portion projects outward from the battery case. On the contrary, by forming the concave portion on the outer surface of the lid plate as described above, interference with the device can be avoided.

The heat transfer inhibiting portion is a groove portion. Accordingly, the heat generated by welding can be more surely inhibited from being transferred to the insulator through the lid plate. That is, since the heat transfer inhibiting portion is the groove portion, the heat transfer in the lid plate can be inhibited more extensively and effectively than that of a case in which the heat transfer inhibiting portion is a hole portion or the like.

The weld portion extends across the opening portion of the outer can and an outer peripheral side of the lid plate from the heat transfer inhibiting portion. Accordingly, the heat generated by welding can be more surely inhibited from being transferred to the insulator by the heat transfer inhibiting portion. Furthermore, when the heat transfer inhibiting portion is the concave portion or the groove portion, the heat generated during welding is inhibited from being transferred to the inner side of the lid plate with respect to the heat transfer inhibiting portion by an air layer within the concave portion or the groove portion. The opening portion of the outer can and a portion on the outer peripheral side of the lid plate from the heat transfer inhibiting portion can thereby be efficiently melted by the welding heat. Consequently, the joint strength of the weld portion between the opening portion of the outer can and the outer peripheral edge portion of the lid plate can be improved.

Also, when the heat transfer inhibiting portion is the concave portion or the groove portion, the weld portion between the opening portion of the outer can and the lid plate is located on the outer peripheral side with respect to the heat transfer inhibiting portion. Thus, the portion melted during welding is pulled toward the opening portion of the outer can almost without being pulled to the inner peripheral side of the lid plate when the molten portion hardens. Accordingly, it is possible to prevent the occurrence of cracks in a mating portion between the opening portion of the outer can and the lid plate when the molten portion hardens.

The weld portion is formed by laser welding. Even when a large quantity of heat is applied to the opening portion of the outer can and the outer peripheral edge portion of the lid plate by irradiating the portions with laser light, it is possible to prevent the insulator from being damaged by the heat generated by welding because of the above configuration.

In the following, the embodiment of the present invention is described in detail by reference to the drawings. Note that the dimensions of constituent members in the respective drawings do not precisely represent the dimensions of actual constituent members, the dimension ratio of respective constituent members, or the like.

### (Entire Configuration)

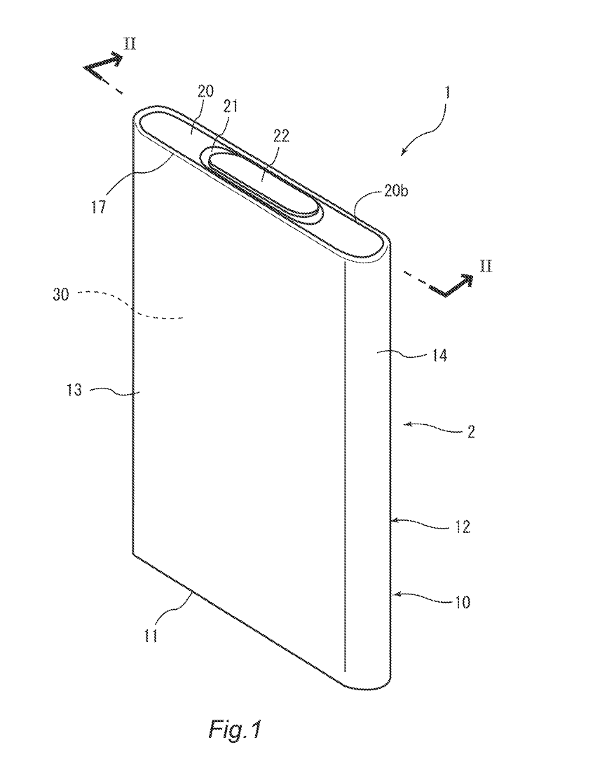

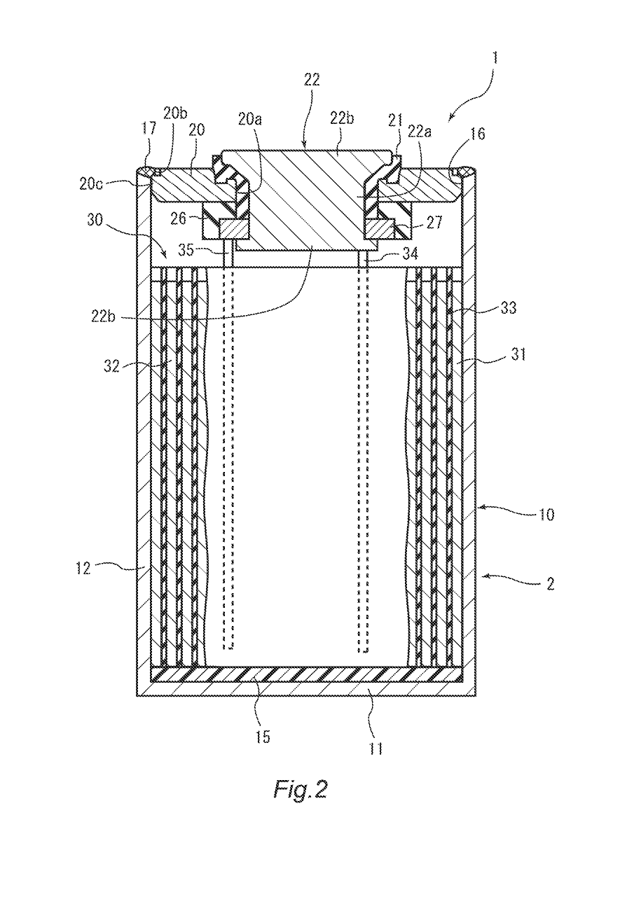

FIG. 1 is a perspective view illustrating the schematic configuration of a sealed battery 1 according to the embodiment of the present invention. The sealed battery 1 includes a bottomed columnar outer can 10, a lid plate 20 that covers an opening portion 16 (see FIG. 2) of the outer can 10, and an electrode assembly 30 that is accommodated in the outer can 10. A columnar battery case 2 having a space therein is constructed by welding the lid plate 20 to the outer can 10. That is, the sealed battery 1 includes the battery case 2. As described below, the sealed battery 1 also includes a negative electrode terminal 22 that penetrates the lid plate 20, and an insulating packing 21 (the insulator) that is arranged between the negative electrode terminal 22 and the battery case 2. A nonaqueous electrolyte (simply referred to as an electrolyte below) is also enclosed in the battery case 2 in addition to the electrode assembly 30. The columnar battery case 2 does not included a cylindrical battery case. As for the columnar battery case 2, a prismatic battery case is preferable.

The electrode assembly 30 is a wound electrode assembly formed by spirally winding a positive electrode 31, a negative electrode 32, and a separator 33, each of which is formed in a sheet-like shape, in a laminated state in the order of, for example, the positive electrode 31, the separator 33, the negative electrode 32, and the separator 33 (see FIG. 2). Although not particularly shown in the drawings, the electrode assembly 30 is crushed and formed into a flat shape after winding the positive electrode 31, the negative electrode 32, and the separator 33 in the laminated state.

Here, FIG. 2 shows only a few layers on the outer peripheral side of the electrode assembly 30. However, an inner peripheral-side portion of the electrode assembly 30 is simply omitted in FIG. 2, and of course, the positive electrode 31, the negative electrode 32, and the separator 33 also exist on the inner peripheral side of the electrode assembly 30. In FIG. 2, illustration of an insulator or the like arranged between the lid plate 20 and the electrode assembly 30 is also omitted.

The positive electrode 31 is obtained by providing positive electrode active material layers containing a positive electrode active material respectively on opposite surfaces of a positive electrode current collector made of metal foil of aluminum or the like. To be more specific, the positive electrode 31 is formed by applying a positive electrode mixture containing the positive electrode active material, which is a lithium-containing oxide capable of absorbing and desorbing lithium ions, a conductive aid, a binder, or the like, onto the positive electrode current collector made of aluminum foil or the like, and drying the positive electrode mixture. For example, a lithium composite oxide, such as a lithium cobalt oxide like LiCoO₂, a lithium manganese oxide like LiMn₂O₄, and a lithium nickel oxide like LiNiO₂, is preferably used as the lithium-containing oxide that is the positive electrode active material. Only one type of material may be used, or two or more types of materials may be used as the positive electrode active material. The positive electrode active material is also not limited to the above materials.

The negative electrode 32 is obtained by providing negative electrode active material layers containing a negative electrode active material respectively on opposite surfaces of a negative electrode current collector made of metal foil of copper or the like. To be more specific, the negative electrode 32 is formed by applying a negative electrode mixture containing the negative electrode active material capable of absorbing and desorbing lithium ions, a conductive aid, a binder, or the like, onto the negative electrode current collector made of copper foil or the like, and drying the negative electrode mixture. For example, a carbon material capable of absorbing and desorbing lithium ions (graphites, pyrolytic carbons, cokes, glassy carbons, etc.) is preferably used as the negative electrode active material. The negative electrode active material is not limited to the above materials.

As shown in FIG. 2, a positive electrode lead 34 is connected to the positive electrode 31 of the electrode assembly 30, while a negative electrode lead 35 is connected to the negative electrode 32. Accordingly, the positive electrode lead 34 and the negative electrode lead 35 are led out of the electrode assembly 30. The distal end side of the positive electrode lead 34 is connected to the lid plate 20. On the other hand, the distal end side of the negative electrode lead 35 is connected to the negative electrode terminal 22 via a lead plate 27 as described below.

The outer can 10 is a bottomed columnar member made of aluminum alloy, and constitutes the battery case 2 together with the lid plate 20 described below. The outer can 10 is a bottomed columnar member having a rectangular bottom surface 11, the short side of which is formed in an arc shape as shown in FIG. 1. To be more specific, the outer can 10 has the bottom surface 11, and a flat-columnar side wall 12 having a smooth curve. The side wall 12 has a pair of flat surface portions 13 (the side surface) facing each other, and a pair of semi-cylindrical portions 14 connecting the flat surface portions 13. The outer can 10 is formed in a flat shape such that a dimension in a thickness direction corresponding to a short side direction of the bottom surface 11 is smaller than a dimension in a width direction corresponding to a long side direction of the bottom surface 11. The outer can 10 also works as a positive electrode terminal of the sealed battery 1 since the outer can 10 is joined to the lid plate 20 that is connected to the positive electrode lead 34 as described below.

As shown in FIG. 2, a bottom insulator 15 composed of a polyethylene sheet is arranged in a bottom portion inside of the outer can 10 so as to prevent the occurrence of short circuit between the positive electrode 31 and the negative electrode 32 of the electrode assembly 30 via the outer can 10. The aforementioned electrode assembly 30 is arranged such that one end portion thereof is located on the bottom insulator 15.

### (Lid Plate)

The lid plate 20 is arranged so as to cover the opening portion 16 of the outer can 10. The lid plate 20 is also joined to the opening portion 16 of the outer can 10 at its outer peripheral edge portion 20c by laser welding. The lid plate 20 is composed of a member made of aluminum alloy similarly to the outer can 10. The short side of the lid plate 20 is formed in an arc shape in plan view such that the lid plate 20 can be fitted to the inner side of the opening portion 16 of the outer can 10. The lid plate 20 also has a larger plate thickness than the thickness of the side wall 12 of the outer can 10.

A through hole 20a is formed in a longitudinal center portion of the lid plate 20. The insulating packing 21 (the insulator) made of polypropylene, and the negative electrode terminal 22 made of stainless steel are inserted into the through hole 20a. More specifically, the roughly-cylindrical insulating packing 21 into which the roughly-columnar negative electrode terminal 22 is inserted is fitted to a peripheral edge portion of the through hole 20a.

The negative electrode terminal 22 has a configuration in which a pair of flat surface portions 22b are respectively formed integrally on both ends of a cylindrical shaft portion 22a. The negative electrode terminal 22 is arranged such that the pair of flat surface portions 22b are exposed from the insulating packing 21, and the shaft portion 22a is located within the insulating packing 21. The lead plate 27 made of stainless steel is electrically connected to the negative electrode terminal 22. Accordingly, the negative electrode terminal 22 is electrically connected to the negative electrode 32 of the electrode assembly 30 via the lead plate 27 and the negative electrode lead 35. A top insulator 26 is arranged between the lead plate 27 and the lid plate 20.

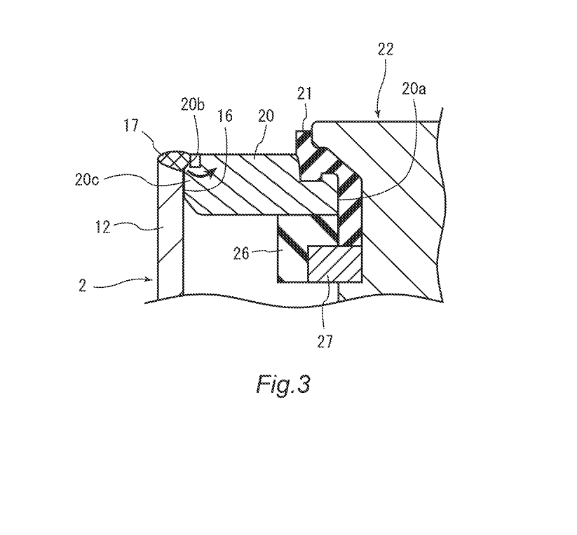

The lid plate 20 and the opening portion 16 of the outer can 10 are joined by laser welding. The outer peripheral edge portion 20c of the lid plate 20 and the opening portion 16 of the outer can 10 are joined over the entire periphery of the lid plate 20. That is, a weld portion 17 is formed over the outer peripheral edge portion 20c of the lid plate 20 and the opening portion 16 of the outer can 10. The weld portion 17 is formed on the outer peripheral side of the battery case 2, and is also formed so as to be curved projecting in a thickness direction of the lid plate 20 when the battery case 2 is viewed in a vertical section as shown in FIGS. 2 and 3. By forming the weld portion 17 as described above, the outermost peripheral side of the opening portion 16 of the outer can 10 has a smoothly-curved outer surface with no corner portion. This eliminates a portion in the sealed battery 1 where stress concentrates when the sealed battery 1 is dropped onto a floor surface or the like to receive an impact. Therefore, the impact resistance of the sealed battery 1 can be improved.

Here, the laser welding is performed by irradiating an object to be welded (the outer can 10 and the lid plate 20) with laser light with a power ranging from, for example, 500 W to 4000 W while varying the power within a time of 1000 is by using a laser welding machine. More specifically, for example, the object to be welded is irradiated with laser light with a power of 500 W during an irradiation time of 0 μs to 100 μs, and laser light with a power of 4000 W during an irradiation time of 100 μs to 200 μs. In the laser welding, the irradiation position (spot) of the object to be welded with the laser light is gradually moved along the outer periphery of the lid plate 20 so as to be partially overlapped with the previous spot.

An effect obtained when the weld portion 17 has a shape as described above is described below.

A drop impact test for the sealed battery was performed by fabricating sealed batteries with weld portions of different shapes so as to examine a difference in effect depending on the shape of the weld portion of the sealed battery.

More specifically, three test pieces, each of which has a flat surface of the weld portion in vertical-sectional view of the sealed battery 1, and three test pieces, each of which has a surface of the weld portion curved in the thickness direction of the lid plate 20 as described above such that an outermost peripheral surface of the opening portion 16 of the outer can 10 has a smooth curve (No. 1 to No. 3 for each of the weld portion shapes), were respectively fabricated. The fabricated test pieces were repetitively dropped onto a concrete floor surface from a height of 1.5 m, and the number of dropping until the weld portion was damaged was counted. It was determined that the weld portion was damaged when the occurrence of a crack in the weld portion could be visually confirmed.

The result of the drop impact test for the sealed battery is shown in Table 1. As shown in Table 1, in the case in which the surface of the weld portion has a flat shape, the weld portion was damaged by a few times of dropping. On the contrary, in the case in which the outer surface of the weld portion is curved such that the outermost peripheral surface of the outer can has a smooth curve, the weld portion was not damaged even when the test pieces were repetitively dropped 20 times. Accordingly, it is found from the result in Table 1 that the weld strength of the weld portion 17 can be improved by curving the outer surface of the weld portion 17 such that the outermost peripheral surface of the opening portion 16 of the outer can has a smooth curve as described above.

TABLE 1

Weld portion surface shape

| | Flat shape | Curve |
|---|---|---|
| No. 1 | Two times | Twenty times |
| No. 2 | Three times | Twenty times |
| No. 3 | Four times | Twenty times |
| Average | Three times | Twenty times |

As shown in FIG. 1, a groove portion 20b (the heat transfer inhibiting portion) having an oval shape in upper view is formed along the outer periphery of the lid plate 20 on an upper surface (surface) of the lid plate 20. That is, in the present embodiment, the groove portion 20b is formed over the entire periphery of the lid plate 20. The groove portion 20b is also formed on the outer peripheral side of the lid plate 20, namely, on the outer peripheral side of the lid plate 20 from the negative electrode terminal 22 and the insulating packing 21. To be more specific, the groove portion 20b is provided on the inner peripheral side of the lid plate 20 from the outer peripheral edge portion 20c, and at a position where a distance to the weld portion 17 is shorter than a distance to the insulating packing 21. Accordingly, heat generated when the outer peripheral edge portion 20c of the lid plate 20 and the opening portion 16 of the outer can 10 are welded together can be effectively inhibited from being diffused over the lid plate 20 by the groove portion 20b. In the present embodiment, the groove portion 20b is formed in, for example, a rectangular shape in section as shown in FIG. 2.

The aforementioned weld portion 17 is formed over the outer peripheral side of the lid plate 20 from the groove portion 20b and the opening portion 16 of the outer can 10. That is, by irradiating a mating portion (contacting portion) between the outer peripheral edge portion 20c of the lid plate 20 and the opening portion 16 of the outer can 10 with laser light, and thereby melting the mating portion, the molten portion becomes the above weld portion 17. The position of the above weld portion 17 is appropriately determined with respect to the mating portion between the opening portion 16 of the outer can 10 and the outer peripheral edge portion 20c of the lid plate 20 such that the outermost peripheral side of the opening portion 16 of the outer can 10 has a smoothly-curved outer surface with no corner portion.

By welding together the outer peripheral edge portion 20c on the outer peripheral side of the lid plate 20 from the groove portion 20b and the opening portion 16 of the outer can 10 as described above, the outer peripheral edge portion 20c of the lid plate 20 is pulled toward the opening portion 16 of the outer can 10 when the portion melted during welding hardens. Accordingly, as compared with a case in which the groove portion 20b is not provided in the lid plate 20, cracks become difficult to occur between the outer peripheral edge portion 20c of the lid plate 20 and the opening portion 16 of the outer can 10.

That is, in the case in which the groove portion 20b is not provided, the mating portion between the outer peripheral edge portion 20c of the lid plate 20 and the opening portion 16 of the outer can 10 is pulled respectively by the lid plate 20 and the outer can 10 due to contraction of the molten portion when the portion melted during welding hardens. Therefore, cracks tend to occur in the mating portion. On the contrary, by providing the groove portion 20b in the lid plate 20 as described above, the outer peripheral edge portion 20c of the lid plate 20 is pulled toward the outer can 10 almost without being pulled to the inner peripheral side of the lid plate 20 when the molten portion hardens. Thus, the occurrence of cracks in the mating portion can be inhibited.

Also, by welding the outer peripheral side with respect to the groove portion 20b in the lid plate 20 as described above, it is possible to prevent the heat from being transferred to the inner peripheral side of the lid plate 20 from the groove portion 20b when the outer peripheral side with respect to the groove portion 20b is irradiated with laser light and thereby melted. That is, by providing the groove portion 20b, a path through which the heat generated during welding by laser light is transferred to the inner peripheral side of the lid plate 20 becomes longer than that of the case in which the groove portion 20b is not provided in the lid plate 20 as indicated by a solid arrow in FIG. 3. Therefore, the heat generated by welding correspondingly becomes difficult to be transferred to the inner peripheral side of the lid plate 20 from the groove portion 20b.

Also, by providing the above groove portion 20b, a heat dissipation area of the surface of the lid plate 20 can be made larger, so that the heat generated in the weld portion 17 can be efficiently dissipated outside of the lid plate 20.

Particularly, it is effective to apply the configuration of the present embodiment to the sealed battery 1 having a small thickness (for example, a battery in which the thickness of the battery case is 3 mm or less, and the width in the battery thickness direction of the flat surface portion 22b of the negative electrode terminal 22 is 2 mm). That is, in the sealed battery 1 having a small thickness, a distance between the weld portion 17 and the insulating packing 21 is small. Thus, the heat generated during welding is easily transferred to the insulating packing 21 through the lid plate 20. Accordingly, by applying the aforementioned configuration to the sealed battery 1 having a small thickness, it is possible to prevent the insulating packing 21 from being damaged by the welding heat.

Moreover, by welding together the outer peripheral side with respect to the groove portion 20b of the lid plate 20 and the opening portion 16 of the outer can 10 as described above, the heat generated during welding can be inhibited from being diffused to the inner peripheral side of the lid plate 20 from the groove portion 20b. Accordingly, the welding heat is accumulated in the weld portion 17 located on the outer peripheral side of the lid plate 20 from the groove portion 20b, so that the outer peripheral edge portion 20c of the lid plate 20 and the opening portion 16 of the outer can 10 can be sufficiently melted. Therefore, the weld strength of the weld portion 17 can be improved.

Note that the groove portion 20b provided in the lid plate 20 may not be provided over the entire periphery of the lid plate 20. That is, the groove portion may be provided in only a portion of the entire periphery of the lid plate 20 that is located at a position where a distance between the insulating packing 21 and the weld portion 17 is shortest. The heat generated during welding is most easily transferred to the insulating packing 21 through the lid plate 20 in the portion where a distance between the weld portion 17 and the insulating packing 21 is shortest. By providing the groove portion in such a portion, it is possible to prevent the insulating packing 21 from being damaged by the welding heat. On the contrary, by providing the groove portion 20b in the lid plate 20 over the entire periphery of the lid plate 20 as in the present embodiment, it is possible to prevent the insulating packing 21 from being damaged by the welding heat over the entire periphery of the lid plate 20, and the weld strength of the weld portion 17 can be also improved.

Also, a hole portion or the like, not the groove portion 20b, may be provided on the upper surface of the lid plate 20. That is, a concave portion such as the groove portion and the hole portion capable of preventing the heat generated during welding from being transferred to the insulating packing 21 through the lid plate 20 may be provided as the heat transfer inhibiting portion. Furthermore, a convex portion, not the concave portion, may be provided on the upper surface of the lid plate 20 as the heat transfer inhibiting portion. A concave-convex portion having at least one of the concave portion and the convex portion may be provided, or a plurality of concave portions or convex portions may be provided on the upper surface of the lid plate 20 as the heat transfer inhibiting portion.

In the present embodiment, the groove portion 20b is provided in the lid plate 20 of the battery case 2 of the sealed battery 1 between the weld portion 17 with the opening portion 16 of the outer can 10 and the insulating packing 21 arranged between the lid plate 20 and the negative electrode terminal 22. Accordingly, the heat generated when the lid plate 20 and the opening portion 16 of the outer can 10 are welded together can be inhibited from being transferred to the insulating packing 21 through the lid plate 20. Therefore, it is possible to prevent the insulating packing 21 from being damaged by the heat generated during welding.

Moreover, by providing the groove portion 20b as described above, and welding the outer peripheral edge portion 20c of the lid plate 20 to the opening portion 16 of the outer can 10, the welding heat can be prevented from being diffused to the inner side of the lid plate 20, and the temperature of the weld portion can be increased. Accordingly, the weld strength of the weld portion 17 can be improved.

Also, by providing the groove portion 20b at least in the portion where a distance between the insulating packing 21 and the weld portion 17 is shortest, a portion of the insulating packing 21 most easily damaged by the heat generated during welding can be more surely protected.

Furthermore, by providing the groove portion 20b in the lid plate 20, and welding the outer peripheral side of the lid plate 20 from the groove portion 20b to the opening portion 16 of the outer can 10, the outer peripheral side of the lid plate 20 from the groove portion 20b is pulled toward the outer can 10 when the weld portion hardens. Accordingly, it is possible to prevent the occurrence of cracks in the mating portion between the outer peripheral edge portion 20c of the lid plate 20 and the opening portion 16 of the outer can 10.

### OTHER EMBODIMENTS

Although the embodiment of the present invention has been described above, the aforementioned embodiment is merely an example for carrying out the present invention. Therefore, the present invention is not limited to the aforementioned embodiment, and the aforementioned embodiment can be modified as appropriate without departing from the scope of the present invention.

In the above embodiment, the groove portion 20b provided in the lid plate 20 has a rectangular shape in section. However, the groove portion 20b may have any sectional shape.

In the above embodiment, the battery case 2 of the sealed battery 1 has the columnar shape having the rectangular bottom surface, the short side of which is formed in an arc shape. However, the battery case may have another shape such as a hexahedron.

In the above embodiment, the sealed battery 1 is configured as a lithium ion battery. However, the sealed battery 1 may be a battery other than the lithium ion battery.

What is claimed is:

1. A sealed battery comprising:
a columnar battery case in which an electrode assembly and an electrolyte are enclosed;
a terminal that projects outward from the battery case; and
an insulator that is arranged between the battery case and the terminal,
wherein the battery case has an outer can having at least one opening portion and constituting a side surface of the battery case, and a lid plate welded to the opening portion of the outer can at an outer peripheral edge portion while the opening portion is covered,
the terminal is electrically connected to the electrode assembly through the lid plate, and
in the lid plate, a heat transfer inhibiting portion is provided between a weld portion of the lid plate with the opening portion of the outer can and the insulator.

2. The sealed battery according to claim 1,
wherein the heat transfer inhibiting portion is provided in a portion on the lid plate where a distance between the insulator and the weld portion is shortest.

3. The sealed battery according to claim 1,
wherein the heat transfer inhibiting portion is provided at a position on the lid plate where a distance to the weld portion is shorter than a distance to the insulator.

4. The sealed battery according to claim 1,
wherein the heat transfer inhibiting portion is a concave-convex portion formed on an outer surface of the lid plate.

5. The sealed battery according to claim 1,
wherein the heat transfer inhibiting portion is a concave portion formed on an outer surface of the lid plate.

6. The sealed battery according to claim 5,
wherein the heat transfer inhibiting portion is a groove portion.

7. The sealed battery according to claim 5,
wherein the weld portion extends across the opening portion of the outer can and an outer peripheral side of the lid plate from the heat transfer inhibiting portion.

8. The sealed battery according to claim 2,
wherein the heat transfer inhibiting portion is a concave-convex portion formed on an outer surface of the lid plate.

9. The sealed battery according to claim 2,
wherein the heat transfer inhibiting portion is a groove portion.

10. The sealed battery according to claim 2,
wherein the weld portion extends across the opening portion of the outer can and an outer peripheral side of the lid plate from the heat transfer inhibiting portion.

11. The sealed battery according to claim 10,
wherein the heat transfer inhibiting portion is a groove portion.

12. The sealed battery according to claim 3,
wherein the heat transfer inhibiting portion is a concave-convex portion formed on an outer surface of the lid plate.

13. The sealed battery according to claim 3,
wherein the heat transfer inhibiting portion is a groove portion.

14. The sealed battery according to claim 3,
wherein the weld portion extends across the opening portion of the outer can and an outer peripheral side of the lid plate from the heat transfer inhibiting portion.

15. The sealed battery according to claim 14,
wherein the heat transfer inhibiting portion is a groove portion.
